(19) United States
(12) Patent Application Publication
(10) Pub. No.: US 2022/0374983 A1
(43) Pub. Date: Nov. 24, 2022

(54) TRADING COMPUTER SYSTEMS AND METHODS FOR USE WITH SHAREHOLDER WARRANTS INCENTIVIZING DELEVERAGING

(71) Applicant: Nabors Drilling Technologies USA, Inc., Houston, TX (US)

(72) Inventors: Anthony PETRELLO, Houston, TX (US); Brendan DYSON, Houston, TX (US)

(21) Appl. No.: 17/746,604

(22) Filed: May 17, 2022

Related U.S. Application Data
(60) Provisional application No. 63/191,102, filed on May 20, 2021.

(51) Int. Cl. G06Q 40/04; G06Q 30/02

(52) U.S. Cl. CPC G06Q 40/04; G06Q 30/0207

(57) ABSTRACT

Systems and methods for deleveraging a company's balance sheet in a non-dilutive fashion that is favorable to the company and equity owners are disclosed. In one embodiment, a computer system identifies equity shareholder accounts by querying a shareholder database and issues shareholder warrants that incentivize deleveraging (“a SWID”) of an issuer to the equity shareholder accounts. The SWID may comprise a right to purchase a share of an issuer's equity at a strike price using the issuer's debt as payment. The system monitors for and detects requests from SWID holder accounts to exercise their SWIDs. When a SWID holder exercises their SWID, the system updates an issuer record database to indicate a reduction of the issuer's debt and assignment of the share to the SWID holder.

### CROSS-REFERENCE TO RELATED APPLICATIONS

This application claims the benefit of U.S. Provisional Application No. 63/191,102, filed May 20, 2021, the entire contents of which is hereby incorporated herein by express reference thereto.

### TECHNICAL FIELD

The present disclosure generally relates to efficient electronic trading computer systems and methods.

### BACKGROUND

Electronic trading computer systems typically stream live market prices on which users can trade and view information related to tradable items such as stocks, bonds, currencies, commodities, derivatives, and others. In some cases, electronic trading computer systems may include trading tools, charting packages, news feeds, and account management functions, among other features. However, there is a need in the art for trading computer systems that can analyze and effectively display information related to shareholder warrants that incentive deleveraging.

### BRIEF DESCRIPTION OF THE FIGURES

FIG. 1A illustrates a flow diagram of a process for using shareholder warrants that incentivize deleveraging of an issuer company in accordance with one or more embodiments of the present disclosure.

FIGS. 1B, 1C, and 1D illustrate examples of Value Capture under three different scenarios in accordance with one or more embodiments of the present disclosure.

FIG. 2 illustrates a block diagram of a networked computer system suitable for implementing one or more embodiments of the present disclosure.

FIG. 3 illustrates a block diagram of a computer system in accordance with one or more embodiments of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, structures and components are shown in block diagram form in order to avoid obscuring the concepts of the subject technology. One or more embodiments of the subject disclosure are illustrated by and/or described in connection with one or more figures and are set forth in the claims.

When public companies are overleveraged, their publicly traded debt securities (e.g., bonds) typically trade at a discount to face value (e.g., par value), which may cause negative effects on the company. For example, a company may be overleveraged (e.g., has more debt than desired) when its ability to make principal and interest payments and to cover operating expenses is impeded. In some cases, a company may be determined to be overleveraged based on a measure of its debt-to-equity ratio or its debt-to-total assets ratio. To deleverage their balance sheet, companies have traditionally had only a few alternative methods, all of which may tend to have significant negative effects on a company and its equity shareholders.

For example, one method for deleveraging is an equity offering. An equity offering typically involves the sale of new equity at a price that is at a deep discount to the current stock price (e.g., the publicly traded stock price in a secondary market). An equity offering is generally dilutive to non-participating shareholders.

Another example of deleveraging is a debt-to-equity exchange. Outside of bankruptcy, debt-to-equity exchanges are typically only conducted in privately negotiated seriatim transactions. Debt-to-equity exchanges can be slow, time-consuming, and dilutive to existing shareholders.

A further example of deleveraging is a rights offering. A rights offering has the benefit of being non-dilutive to equity holders (at least those who elect to participate, and all equity holders are offered the right to participate), but to ensure that the funds are duly raised, rights offerings often take the form of a capital raise at a substantial discount to the market rate. In this sense, rights offerings are not “shareholder friendly” and may be viewed as coercive by existing shareholders.

Bankruptcy reorganization is another example of deleveraging. Most bankruptcies of overleveraged companies today are resolved through a conversion of debt to equity, but the process typically is driven by the debt holders using existing bankruptcy legal regimes and results in only de minimis consideration to shareholders, if any.

The present disclosure provides systems and methods for making changes in a company's capitalization structure to deleverage the company's balance sheet in a non-dilutive fashion that is favorable to the company and its equity owners (e.g., shareholders).

In an embodiment of the present disclosure, a shareholder warrant that incentivizes deleveraging (“SWID”) is provided. The SWID may be public registered, tradeable, and designed to create a path to efficiently deleveraging while being non-coercive to equity or debt holders and non-dilutive to shareholders. The SWID may be issued by an overleveraged company (e.g., the issuer), or by a company viewed as being overleveraged by the market or some of its investors, to each of its equity shareholders. The warrant may include a right to buy one share of the company's equity over a limited period of years at a strike price (e.g., the price payable by the holder of the SWID to buy the share) that is payable (as an alternative to cash) using the company's publicly traded debt, which may be valued for such purpose at face value rather than then-current market price. Since publicly traded debt is generally issued in denominations of $1,000, a single bond may constitute the exercise price for multiple SWIDs.

The following is an illustration of the terms of a SWID in one or more embodiments of the present disclosure. Assume for the illustration that there is a current market price of $100 per share.

Strike Price. A strike price of the SWID may be set at a premium to market price—in this illustration, the strike price may be $166.66667.

Maturity Term. A maturity term may be any length greater than 1 year—in this illustration, the maturity term may be 5 years.

Distribution Ratio. A distribution ratio may be a ratio commensurate to the amount of deleveraging targeted. In this illustration, one warrant can be distributed for every two outstanding shares. This would result in a distribution ratio of 1 to 2. Thus, the higher the distribution ratio, the greater the potential deleveraging.

Strike Price Payment. A strike price payment term may indicate methods of payment accepted when exercising the SWID. The SWID may be exercised through the payment of the strike price in cash. However, in addition to or instead of cash, the SWID may be exercised at the election of the shareholder by delivery of any identified set of outstanding bonds and credit can be received by the SWID holder for the complete face value of the bonds regardless of the then-current trading value of the bonds on the date of exercise. For example, if full face value of a bond is $1000 but the public trading value of the bond on the date of exercise is $950, the SWID holder would receive credit for the $1000 face value of the bond rather than the trading value of $950. In addition, any accrued unpaid interest that is due on the bonds can be paid by the issuer (e.g., the deleveraging company) at the time of exercise in cash or in additional shares valued on the date of exchange using defined volume-weighted average price (VWAP) or other suitable formulas. These valuations tend to be determined by dynamic calculations based on the pricing over a period of time (e.g., 3 to 10 business days).

Early Exercise Bonus. An early exercise bonus term may define an early exercise price to encourage exercise of the SWID before the market share price reaches the strike price. The early exercise price may be any number between the market share price on the

SWID announcement date or the strike price, but typically may be approximately at a halfway point between the market share price on the SWID announcement date and the strike price. In this illustration, the early exercise price may be $125. On any day that the company stock trades at an early threshold percentage (e.g., 10% in this illustration) above a defined trailing price (e.g., 3-day VWAP), the SWID holder would be entitled to bonus shares of a percent of a share (e.g., the bonus share number in this illustration may be 0.2 additional shares for every SWID). If the stock trades above the early exercise price, the right to use bonds as payment is eliminated at the option of the company.

Early Retirement. An early retirement term may define the days prior to maturity that the warrants may be retired by the issuer. In some cases, there may be a retirement notice period such as 20 days of notice, for example.

Once SWIDs are issued by a deleveraging company and as a stock price of the deleveraging company rises, the SWID holders (who may initially be equity shareholders) may acquire bonds, issued by the company and now publicly trading at a discount, to use in buying new shares by exercising their SWIDs. This allows the SWID holders to capture a portion of the trading discount of the bonds. Likewise, bond holders can purchase SWIDs and use their bonds to monetize the bonds at a value greater than the then trading price of the bonds (e.g., the face value of the bonds will be greater than the then-trading value of the bonds). On days open for early exercise bonus, both shareholders and bondholders will be incentivized to exercise SWIDs to take advantage of the premium payment in additional shares.

Depending on the trading discounts of the bond, the deleveraging company's overall leverage and market capitalization, each of the following levers can be adjusted to maximize the probability of achieving the targeted leverage reduction: the strike price, the maturity term, the distribution ratio, the early exercise price and early threshold percentage, and the retirement notice period.

Using SWIDs provides several advantages over other deleveraging alternatives. For example, SWIDs are non-dilutive and non-coercive to shareholders. The structure of SWID issuances permits large blocks of equity to be monetized, including obviating the need to have a shareholder vote for issuing equity equal to more than 20 percent of shares outstanding. SWIDs give bondholders access to a market at a premium with more liquidity to monetize their bonds. SWIDs place shareholders in charge of deleveraging, and the shareholders can directly reap the benefits of bond discount capture on deleveraging company's bonds if they so choose. Further, if a shareholder does not participate in a SWID issuance, the shareholder may still benefit from the expected valuation enhancement of the issuer due to the reduced leverage. Finally, SWIDs reduce the likelihood of companies being forced into bankruptcy due to overleverage. Additional benefits will be appreciated in view of the discussion below.

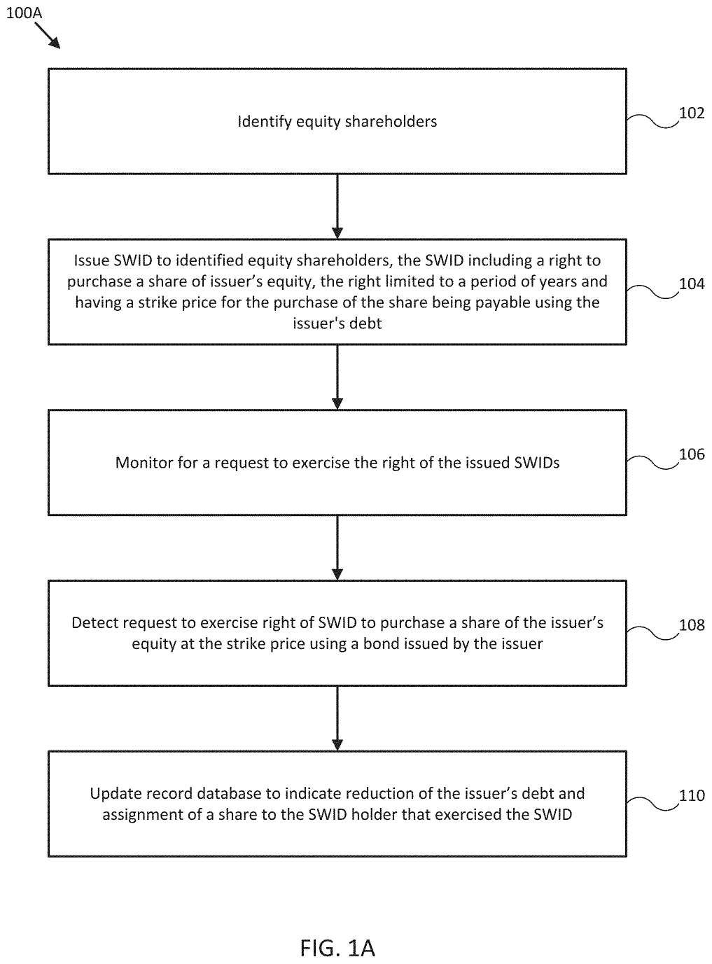

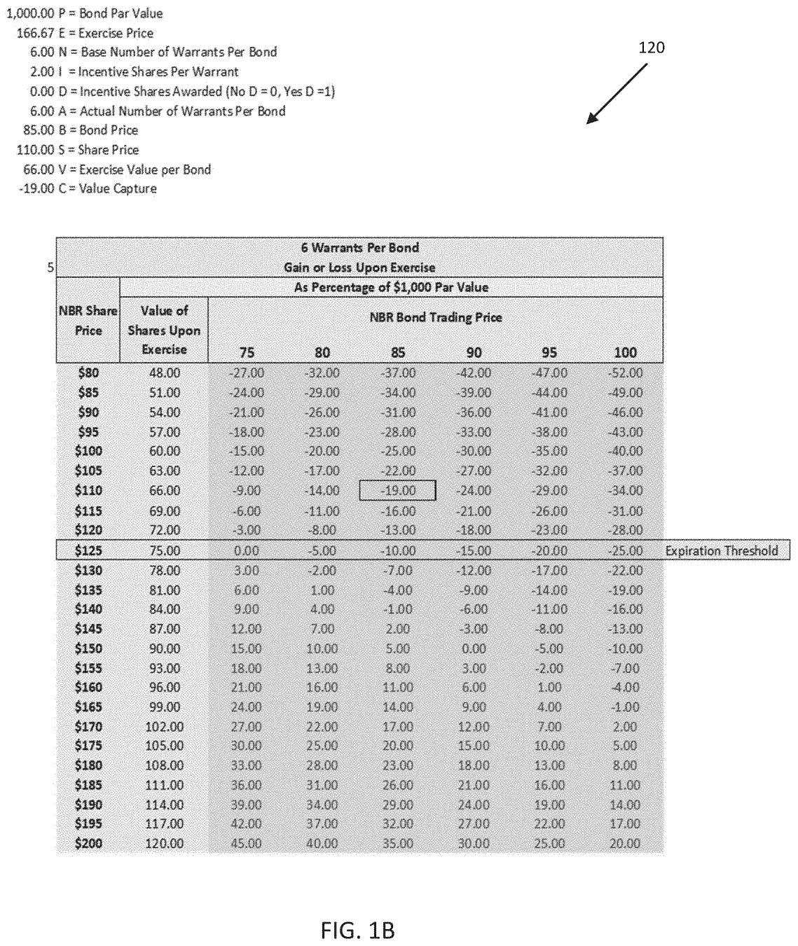

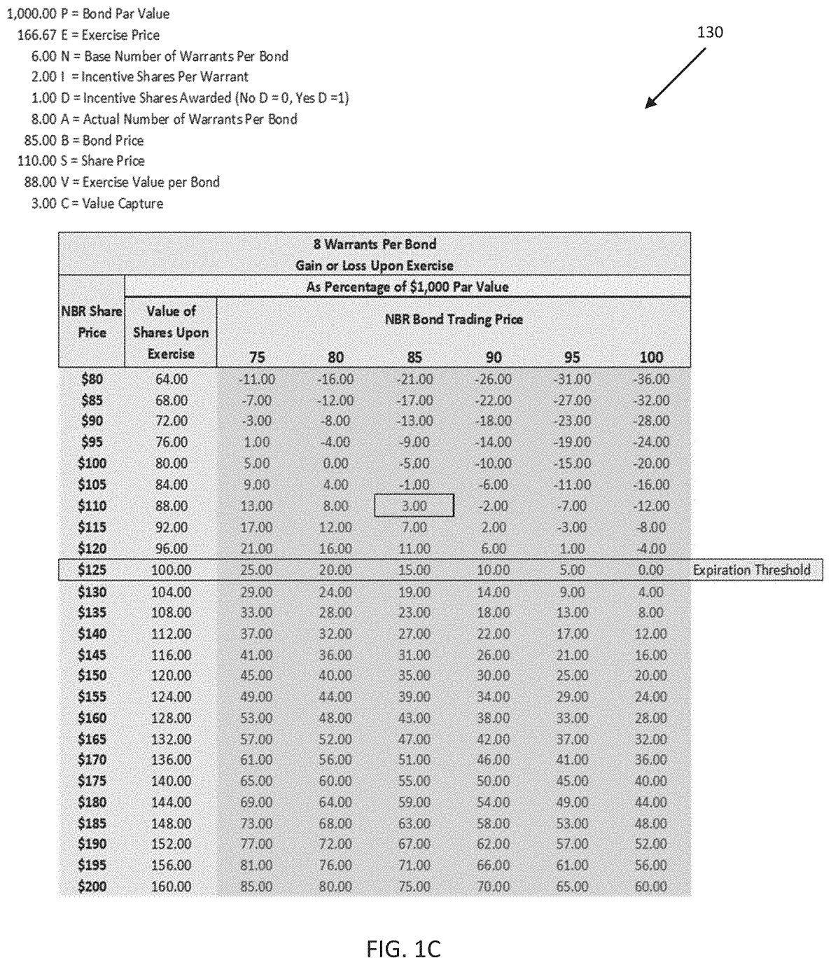

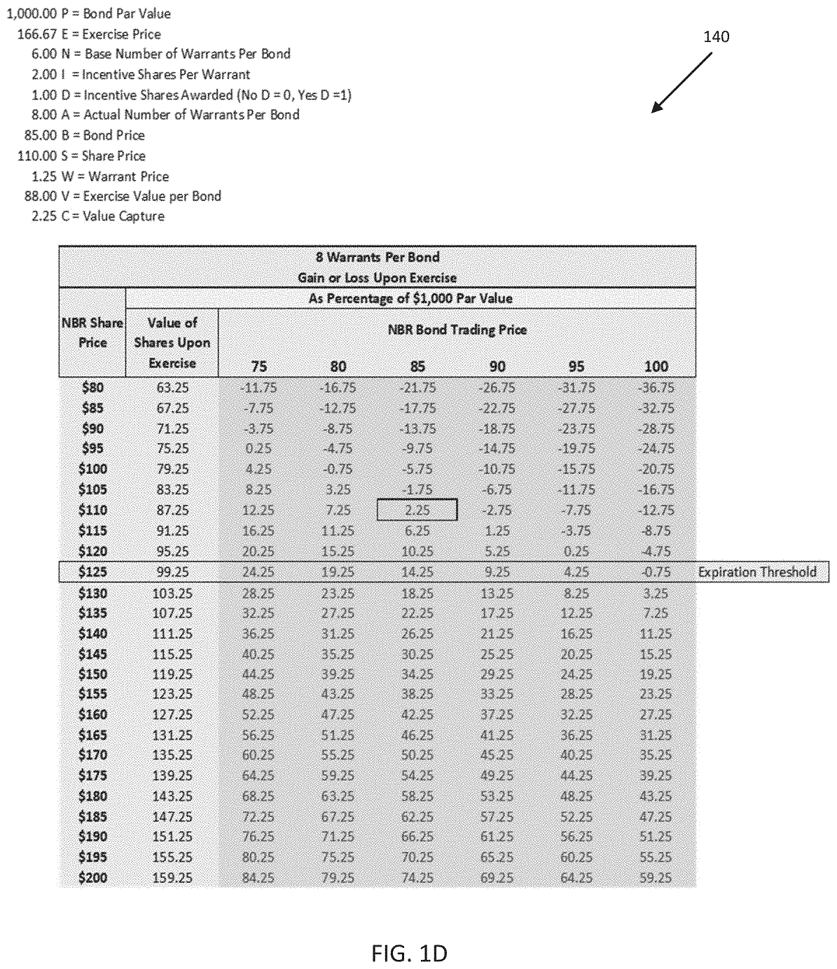

Referring now to FIG. 1A, illustrated is a flow diagram of a process 100A for using SWIDs in accordance with one or more embodiments of the present disclosure. The blocks of process 100A are described herein as occurring in serial, or linearly (e.g., one after another). However, multiple blocks of process 100A may occur in parallel. In addition, the blocks of process 100A need not be performed in the order shown and/or one or more of the blocks of process 100A need not be performed. It is noted that several of the steps and sub-steps in the blocks of process 100A may be described in reference to the additional figures of the present disclosure. Process 100A may be performed by a computer system comprising a non-transitory memory storing instructions and at least one hardware processors configured to execute the instructions to cause the system to perform process 100A. In various embodiments, a non-transitory machine-readable medium may have computer-readable instructions stored thereon which are executable to cause a machine to perform process 100A.

At block 102, the system may identify equity shareholders of a company. For example, the system may access a shareholder database and identify from the shareholder database, each of the current shareholders of the company (e.g., using a query to the database). The company may be overleveraged, or viewed as overleveraged, and may have a desire to deleverage its balance sheet using SWIDs.

At block 104, the system may issue a SWID to the identified equity shareholders. In an embodiment, the system may update an account associated with the identified shareholders to reflect control of the issued SWID. For example, the system may request the shareholder database to update the account associated with the dynamically identified equity shareholders on a particular date to reflect the issuance of the SWID. In some embodiments, more than one SWID may be issued to the identified equity shareholders, such as according to a distribution ratio (e.g., 3 SWIDs for each 1 share), however, reference is made herein to one SWID for simplicity of explanation. The SWID associated with the identified equity shareholder's account may include defining characteristics such as a strike price, maturity term, strike price payment, early exercise bonus, early threshold percentage, and early retirement as described herein.

In some embodiments, the equity shareholders may log in to their respective accounts on a computing device (e.g., laptop, tablet computer, smartphone) to view their held SWIDs and the defining characteristics of the SWIDs. In some embodiments, the equity shareholders may log in to their accounts using a dedicated computer application that has a graphic user interface that allows the user to view the SWIDs, the defining characteristics of the SWIDs, and relevant public trading information such as the stock price of the deleveraging company, the bond price of the deleveraging company, the price of the SWIDs trading on a secondary market, and any analytical information related to the exercise of the SWIDs. The analytical information may be calculated using various sources of information (e.g., fetched via the Internet) including the SWIDs and their defining characteristics and the relevant public trading information. Various alerts, including visual and audible as well as push notifications to a computing device, may be set up to trigger based on the analytical information. The analytical information may be graphically displayed so as to allow for a user (e.g., a SWID holder, security trader, etc.) to make decisions based on real time data and in a convenient and time-efficient manner.

In some embodiments, the analytical information may include a shareholder value capture algorithm. Below is a formula that may be implemented in the shareholder value capture algorithm.

Shareholder Value Capture Formula:

P=Bond Par Value

E=Exercise Price

N=Base Number of Warrants Per Bond

I=Incentive Shares Per Warrant

D=Incentive Shares Awarded (No D=0, Yes D=1)

A=Actual Number of Warrants Per Bond

B=Bond Price

S=Share Price

V=Exercise Value per Bond

C=Value Capture

P/E=N

N+(N×I×D)=A

S×A=V

V−B=C

In some embodiments, the analytical information may include a bondholder value capture algorithm. Below is a formula that may be implemented in the bondholder value capture algorithm.

Bondholder Value Capture Formula:

P=Bond Par Value

E=Exercise Price

N=Base Number of Warrants Per Bond

I=Incentive Shares Per Warrant

D=Incentive Shares Awarded (No D=0, Yes D=1)

A=Actual Number of Warrants Per Bond

B=Bond Price

S=Share Price

W=Warrant Price

V=Exercise Value per Bond

C=Value Capture

P/E=N

N+(N×I×D)=A

S×A=V

V−(W×N)−B=C

In some embodiments, the system (or computing device of a user) may detect an execution event based on the analytical information. For example, the computing device of the SWID holder may detect an execution event based on the shareholder value capture formula above, such as when C exceeds a certain threshold (e.g., a zero threshold or defined value threshold). Similarly, the computing device may detect an execution event based on the bondholder value capture formula above, such as when C exceeds a certain threshold. When execution events are detected, the computing device may perform one or more actions, such as automatically performing a trade for a user, pushing a recommendation notification to a user device associated with the user (e.g., a mobile device) where the user can conveniently authorize the trade via a graphical user interface, or displaying an alert in a display device associated with the computing device.

As an example, in one embodiment, when C is above a defined threshold in the shareholder value capture formula, the computing device of a SWID holder may automatically exercise SWID(s). As another example, in one embodiment, when C is above defined threshold in the bondholder value capture formula, the computing device of a bondholder may automatically purchase publicly traded SWID(s) and exercise the SWID(s) using the bonds held by the bondholder as payment for shares.

FIGS. 1B, 1C, and 1D illustrate examples of computing C (Value Capture) under three different scenarios. Specifically, FIG. 1B illustrates a chart 120 that includes various computed Cs (Value Captures) based on different bond prices and share prices under a scenario for a shareholder, where incentive shares are not awarded. As shown in the figure, when the bond price is at $85 and the share price is at $110, the Value Capture is computed as −19 using the Shareholder Value Capture Formula above. According to the chart 120, the system may determine for a shareholder who has not been awarded incentive shares, that an execution event may occur when a particular bond price and a particular share price result in a C (Value Capture) above 0 (e.g., when the bond price is at $75 and the share price is at $130).

FIG. 1C illustrates a chart 130 that includes various computed Cs (Value Captures) based on different bond prices and share prices under a scenario for a shareholder, where incentive shares are awarded. As shown in the figure, when the bond price is at $85 and the share price is at $110, the Value Capture is computed as 3 using the Shareholder Value Capture Formula above. According to the chart 130, the system may determine for a shareholder who has been awarded incentive shares, that an execution event may occur when a particular bond price and a particular share price result in a C (Value Capture) above 0 (e.g., when the bond price is at $75 and the share price is at $95).

FIG. 1D illustrates a chart 140 that includes various computed Cs (Value

Captures) based on different bond prices and share prices under a scenario for a bondholder, where incentive shares are awarded. As shown in the figure, when the bond price is at $85 and the share price is at $110, the Value Capture is computed as 2.25 using the Bondholder Value Capture Formula above. According to the chart 140, the system may determine for a bondholder who has been awarded incentive shares, that an execution event may occur when a particular bond price and a particular share price result in a C (Value Capture) above 0 (e.g., when the bond price is at $75 and the share price is at $95).

In some embodiments, charts 120, 130, and 140 may be integrated into a graphical user interface to allow a user to quickly and conveniently view theoretical gains or losses in relation to the exercise of SWIDs.

Referring back to FIG. 1A, at block 106, the system may monitor for a request from SWID holder (e.g., a client device) to exercise the right of the issued SWIDs to purchase a share of the issuer's (e.g., the deleveraging company's) equity at the strike price of the SWID and using the issuer's debt (e.g., priced in real-time as discussed herein) to pay for the equity. As a stock price of the deleveraging company rises, SWID holders (who may initially be the equity shareholders but can also be SWID holders on a secondary market) may acquire bonds, issued by the company and now publicly trading at a discount, to use in buying new shares by exercising their SWIDs. This allows the SWID holders to capture a portion of the trading discount of the bonds. Likewise, bond holders can purchase SWIDs and use their bonds to monetize the bonds at a value greater than the then trading price of the bonds (e.g., the face value of the bonds will be greater than the then trading value of the bonds). On days open for early exercise bonus, both shareholders and bondholders will be incentivized to exercise SWIDs to take advantage of the premium payment in additional shares.

At block 108, the system may detect a request to exercise a SWID to purchase a share of the issuer's equity at the strike price of the SWID and using a bond issued by the issuer. The request may include personal information and an identifier for one or more bonds owned by the SWID holder and that the SWID holder would like to use in purchasing the share(s) of the issuer's equity. The system may confirm that the SWID holder owns the bonds by querying a bond holder database using the personal information of the SWID holder found in the request and the identifier of the bonds. If the system determines that the SWID holder indeed owns the bonds, the system may verify that the characteristics of SWID. For example, the system may verify that the SWID maturity term has not expired or that the SWID has not been retired by the issuer.

At block 110, the system may update a company record database based on the exercise of the SWID to indicate a reduction of the issuer's outstanding debt and assignment of a share to the SWID holder that exercised the SWID.

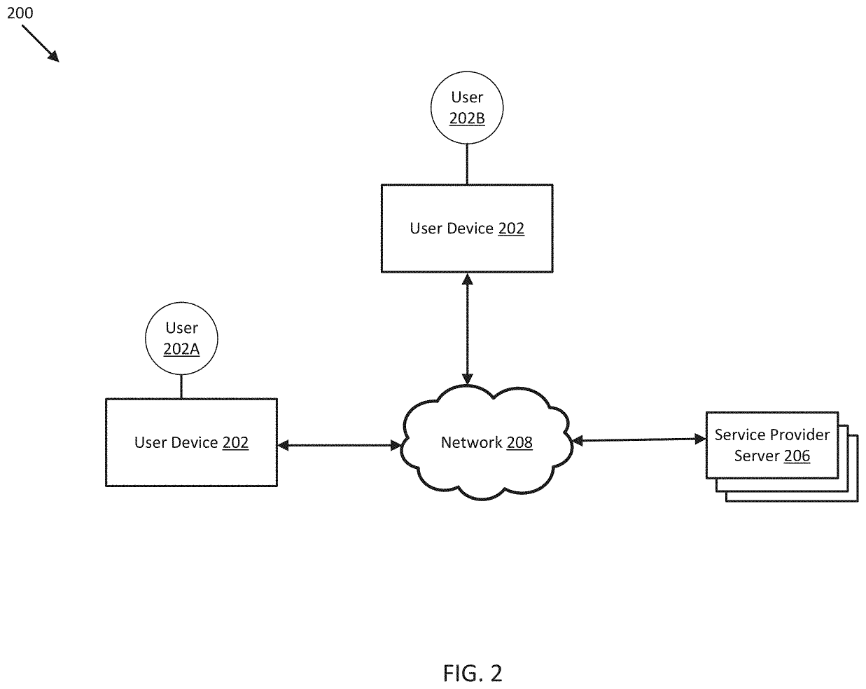

FIG. 2 illustrates a block diagram of a networked system 200 configured smart cloud caching using edge compute and real-time customer journey insights in accordance with one or more embodiments of the present disclosure. System 200 includes user devices 202 and 204 and service provider server(s) 206. A user 202A is associated with user device 202, where user 202A can provide an input to service provider server 206 using user device 202.

User device 202 and service provider server 206 may each include one or more processors, memories, and other appropriate components for executing computer-readable instructions such as program code and/or data stored on one or more computer-readable mediums to implement the various applications, data, and steps described herein. For example, such instructions may be stored in one or more computer-readable media such as memories or data storage devices internal and/or external to various components of system 200, and/or accessible over a network 208. Each of the memories may be non-transitory memory. Network 208 may be implemented as a single network or a combination of multiple networks. For example, in various embodiments, network 208 may include the Internet or one or more intranets, landline networks, and/or other appropriate types of networks.

User device 202 may be implemented using any appropriate hardware and software configured for wired and/or wireless communication over network 208. For example, in some embodiments, user device 202 may be implemented as a personal computer (PC), a mobile phone, personal digital assistant (PDA), laptop computer, and/or other types of computing devices capable of transmitting and/or receiving data, such as an iPhone®, Apple Watch®, or iPad® from Apple® or similar devices from Google, Nokia, or the like.

User device 202 may include one or more browser applications which may enable the user device 202 to various web applications provided by service provider server(s) 206 over network 208. User device 202 may also include one or more toolbar applications which may be used, for example, to provide client-side processing for performing desired tasks in response to operations selected by user 202A. In one embodiment, the toolbar application may display a user interface in connection with the browser application.

User device 202 may further include other applications as may be desired in particular embodiments to provide desired features to user device 202. For example, the other applications may include an application to interface between service provider server 206 and the network 208, security applications for implementing client-side security features, programming client applications for interfacing with appropriate application programming interfaces (APIs) over network 208, or other types of applications. In some cases, the APIs may correspond to service provider server 206. The applications may also include email, texting, voice, and instant messaging applications that allow user 202A to send and receive emails, calls, and texts through network 208, as well as applications that enable the user to communicate to service provider server 206 as discussed above. User device 202 includes one or more device identifiers which may be implemented, for example, as operating system registry entries, cookies associated with the browser application, identifiers associated with hardware of user device 202, or other appropriate identifiers, such as those used for user, payment, device location, and or authentication. In some embodiments, a device identifier may be used by service provider server 206 to associate user 202A with a particular account maintained by the service provider server 206. A communications application with associated interfaces facilitates communication between user device 202 and other components within system 200. User device 204 associated with user 202B may be similar to user device 202.

Service provider server 206 may be maintained, for example, by an online cloud service provider. In this regard, service provider server 206 includes one or more applications which may be configured to interact with user device 202 and user device 204 over network 208 to facilitate the provision of client application functionality as discussed in the present disclosure. Service provider server 206 maintains a plurality of user accounts (e.g., stored in a user account database accessible by service provider server 206), each of which may include individual user data and preferences.

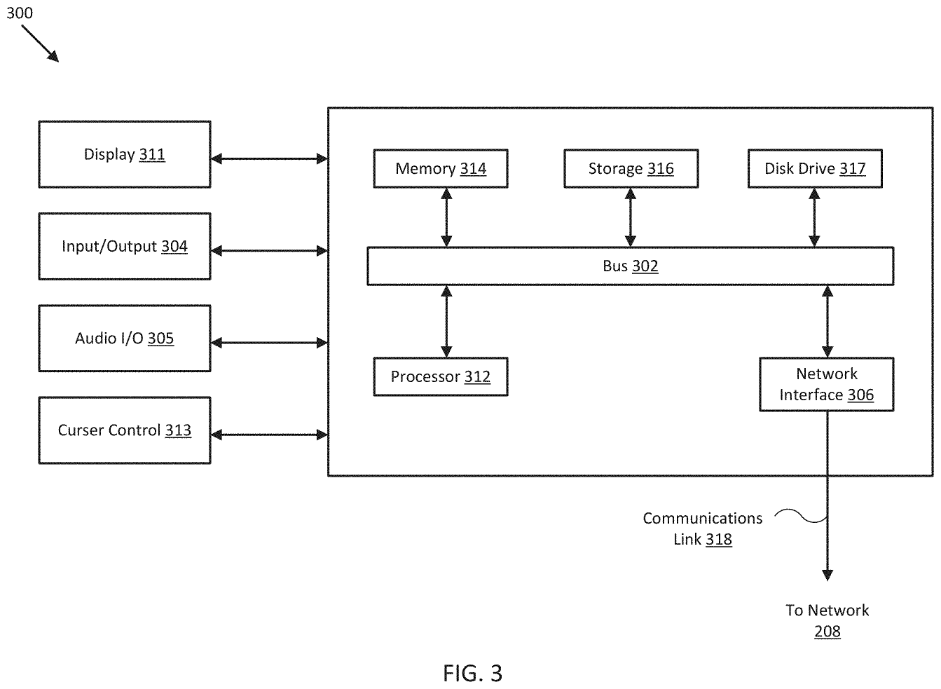

FIG. 3 illustrates a block diagram of a computer system 300 suitable for implementing one or more embodiments of the present disclosure. In various implementations, the computer system 300 may comprise a personal computing device (e.g., a personal computer, laptop, smart phone, PDA, Bluetooth device, key FOB, badge, wearable device such as a smart watch, smart TV, or any other visual accessibility capable device) and/or a server computing device. It should be appreciated that each of the devices utilized by users and service providers discussed herein may be implemented as computer system 300 in a manner as follows.

Computer system 300 includes a bus 302 or other communication mechanism for communicating information data, signals, and information between various components of computer system 300. Components include an input/output (I/O) component 304 that processes a user action, such as selecting keys from a keypad/keyboard, selecting one or more buttons or links, etc., and sends a corresponding signal to bus 302. I/O component 304 may also include an output component, such as a display 311 and a cursor control 313 (such as a keyboard, keypad, mouse, etc.). I/O component 304 may further include NFC communication capabilities. An optional audio I/O component 305 may also be included to allow a user to use voice for inputting information by converting audio signals. Audio I/O component 305 may allow the user to hear audio such as audible descriptions provided by a screen reader application. A transceiver or network interface 306 transmits and receives signals between computer system 300 and other devices, such as another user device, an entity server, and/or a provider server via network 208. In one embodiment, the transmission is wireless, although other transmission mediums and methods may also be suitable. Processor 312, which may be one or more hardware processors, can be a micro-controller, digital signal processor (DSP), or other processing component, processes these various signals, such as for display on computer system 300 or transmission to other devices via a communication link 318. Processor 312 may also control transmission of information, such as cookies or IP addresses, to other devices.

Components of computer system 300 also include a system memory component 314 (e.g., RAM), a static storage component 316 (e.g., ROM), and/or a disk drive 317. Computer system 300 performs specific operations by processor 312 and other components by executing one or more sequences of instructions contained in system memory component 314. Logic may be encoded in a computer-readable medium, which may refer to any medium that participates in providing instructions to processor 312 for execution. Such a medium may take many forms, including but not limited to, non-volatile media, volatile media, and transmission media. In various implementations, non-volatile media includes optical or magnetic disks, volatile media includes dynamic memory, such as system memory component 314, and transmission media includes coaxial cables, copper wire, and fiber optics, including wires that comprise bus 302. In one embodiment, the logic is encoded in non-transitory computer readable medium. In one example, transmission media may take the form of acoustic or light waves, such as those generated during radio wave, optical, and infrared data communications.

Some common forms of computer readable media include, for example, solid-state drive, floppy disk, flexible disk, hard disk, magnetic tape, any other magnetic medium, CD-ROM, any other optical medium, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 318 to the network 208 (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure.

What is claimed is:

1. A computer system comprising:
a non-transitory memory storing computer-readable instructions; and
one or more hardware processors configured to execute the instructions to cause the system to perform operations comprising:
in response to receiving a request from an issuer to issue shareholder warrants that incentivize deleveraging (“SWIDs”) of an issuer, identifying equity shareholder accounts by querying a shareholder database;
issuing the SWIDs to the equity shareholder accounts, wherein each of the SWIDs comprises a right to purchase a share of the issuer's equity at a strike price using the issuer's debt as payment;
monitoring for requests from SWID holder accounts to exercise the right of respective SWIDs;
detecting a request from a SWID holder account to exercise the right of a SWID to purchase a share of the issuer's equity at the strike price using a bond previously issued by the issuer; and
updating an issuer record database to indicate a reduction of the issuer's debt and assignment of the share to the SWID holder.

2. The computer system of claim 1, wherein the operations further comprise:
retrieving, from one or more data sources, information associated with the issuer via a network;
calculating analytical information related to exercising the rights of the SWIDs; and
detecting an execution event based on the analytical information.

3. The computer system of claim 2, wherein the operations further comprise:
in response to the detecting the execution event, providing, on a graphical user interface displayed on a user device associated with the SWID holder account, a recommendation for exercising the right of the SWID.

4. The computer system of claim 2, wherein the operations further comprise:
generating, for the SWID holder account, the request to exercise the right of the SWID in response to the detecting the execution event.

5. The computer system of claim 2, wherein the information associated with the issuer comprises at least one of a bond exercise value of the issuer or a bond price of the issuer.

6. The computer system of claim 5, wherein the analytical information comprises at least a difference between the bond exercise value and the bond price.

7. The computer system of claim 2, wherein the operations further comprise:
providing, on a graphical user interface displayed on a user device associated with the SWID holder account, the analytical information.

8. The computer system of claim 1, wherein the operations further comprise:
verifying, using the issuer record database, that the SWID is owned by the SWID holder account.

9. A method of issuing a warrant incentivizing deleveraging, comprising:
receiving, by a processor, a request for issuing shareholder warrants that incentivize deleveraging (“SWIDs”) of an issuer;
in response to the receiving the request, identifying, by the processor, a plurality of equity shareholder accounts holding shares of the issuer by querying a shareholder database;
issuing, by the processor, a SWID to each of the equity shareholder accounts, wherein each SWID comprises a right to purchase a share of the issuer's equity at a strike price using the issuer's debt as payment;
monitoring, by the processor, for requests from SWID holder accounts to exercise the right of respective SWIDs;
detecting, by the processor, a request from a SWID holder account to exercise the right of a SWID to purchase a share of the issuer's equity at the strike price using a bond previously issued by the issuer; and
updating, by the processor, an issuer record database to indicate a reduction of the issuer's debt and assignment of the share to the SWID holder.

10. The method of claim 9, further comprising:
retrieving, from one or more data sources, information associated with the issuer via a network;
calculating analytical information related to exercising the rights of the SWIDs; and
detecting an execution event based on the analytical information.

11. The method of claim 10, further comprising:
in response to the detecting the execution event, providing, on a graphical user interface displayed on a user device associated with the SWID holder account, a recommendation for exercising the right of the SWID.

12. The method of claim 10, further comprising:
generating, for the SWID holder account, the request to exercise the right of the SWID in response to the detecting the execution event.

13. The method of claim 10, wherein the information associated with the issuer comprises at least one of a bond exercise value of the issuer or a bond price of the issuer.

14. The method of claim 13, wherein the analytical information comprises at least a difference between the bond exercise value and the bond price.

15. The method of claim 10, further comprising:
providing, on a graphical user interface displayed on a user device associated with the SWID holder account, the analytical information.

16. The method of claim 9, further comprising:
verifying, using the issuer record database, that the SWID is owned by the SWID holder account.

17. A non-transitory computer-readable medium storing instructions that when executed by a processor causes the processor to perform operations comprising:
in response to receiving a request from an issuer to issue shareholder warrants that incentivize deleveraging (“SWIDs”) of an issuer, identifying equity shareholder accounts by querying a shareholder database;
issuing the SWIDs to the equity shareholder accounts, wherein each of the SWIDs comprises a right to purchase a share of the issuer's equity at a strike price using the issuer's debt as payment;
monitoring for requests from SWID holder accounts to exercise the right of respective SWIDs;
detecting a request from a SWID holder account to exercise the right of a SWID to purchase a share of the issuer's equity at the strike price using a bond previously issued by the issuer; and
updating an issuer record database to indicate a reduction of the issuer's debt and assignment of the share to the SWID holder.

18. The non-transitory computer-readable medium of claim 17, wherein the operations further comprise:
retrieving, from one or more data sources, information associated with the issuer via a network;
calculating analytical information related to exercising the rights of the SWIDs; and
detecting an execution event based on the analytical information.

19. The non-transitory computer-readable medium of claim 18, wherein the operations further comprise:
in response to the detecting the execution event, providing, on a graphical user interface displayed on a user device associated with the SWID holder account, a recommendation for exercising the right of the SWID.

20. The non-transitory computer-readable medium of claim 18, wherein the operations further comprise:
generating, for the SWID holder account, the request to exercise the right of the SWID in response to the detecting the execution event.
